(19) United States
(12) Patent Application Publication
(10) Pub. No.: US 2010/0099063 A1
(43) Pub. Date: Apr. 22, 2010

(54) WAGERING GAME EDUCATIONAL SYSTEM

(75) Inventors: Steven R. Cramer, Mundelein, IL (US); Cris Challender, Lake in the Hills, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS Gaming Inc., Waukegan, IL (US)

(21) Appl. No.: 12/298,676

(22) Filed: Oct. 27, 2008

Related U.S. Application Data
(63) Continuation-in-part of application No. PCT/US2007/023500, filed on Nov. 8, 2007.
(60) Provisional application No. 60/857,989, filed on Nov. 10, 2006.
(60) Provisional application No. 60/982,556, filed on Oct. 25, 2007.

(51) Int. Cl. G09B 19/22; A63F 9/24

(52) U.S. Cl. 434/128; 463/16

(57) ABSTRACT

A computerized wagering game education system includes presentation of one or more interactive wagering game technical tasks to a student, presentation of a quiz to a student via the network interface such that the quiz results are used to provide suggestions for further study, and presenting multiple levels of testing to a student as part of a certification process, comprising at least one quiz presented after the completion of at least one course and at least one certification test presented at the completion of multiple courses.

### RELATED APPLICATIONS

This patent application is a Continuation In Part under 35 U.S.C. 111(a) of PCT/US2007/023500, filed Nov. 8, 2007, and published on May 22, 2008, as WO 2008/060427 A2 and republished as WO 2008/060427 A3, which claims the priority benefit of U.S. Provisional Patent Application Ser. No. 60/857,989 filed Nov. 10, 2006, the contents of which are incorporated herein by reference in their entirety.

This application also claims priority to U.S. Provisional Patent Application Ser. No. 60/982,556 filed Oct. 25, 2007, the content of which is incorporated herein by reference in its entirety.

### FIELD OF THE INVENTION

The invention relates generally to wagering game system education, and more specifically to a system for providing wagering game system technical education.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio, video, and mechanical features into wagering game systems enhance the environment presented are therefore important elements in the attractiveness and commercial success of a computerized wagering game system. Further, a variety of network configurations and capabilities are becoming increasingly common, including local and wide area progressive games, downloadable games, and remotely managed wagering game systems.

These increasingly complex functions require specialized knowledge and training beyond simply uncrating a wagering game machine and plugging it in to a power source, as was possible with early wagering game machines. A variety of topics, including network configuration, game configuration, community game system configuration, and regulation compliance must be understood by a wagering game technician in various environments to ensure a successful wagering game system installation. Proper setup and configuration of a wagering game system is therefore often dependent on proper training and adequate skill development on a variety of gaming-specific subjects.

### SUMMARY

Various example embodiments of the invention comprise a computerized wagering game education system operable to present one or more interactive wagering game technical tasks to a student, to present a quiz to a student via the network interface such that the quiz results are used to provide suggestions for further study, and to present multiple levels of testing to a student as part of a certification process, comprising at least one quiz presented after the completion of at least one course and at least one certification test presented at the completion of multiple courses.

### BRIEF DESCRIPTION OF THE FIGURES

FIG. 1 shows a computerized wagering game machine, as may be used to practice some example embodiments of the invention.

FIG. 2 is a block diagram of a wagering game system, consistent with some example embodiments of the invention.

FIG. 3 shows a portable wagering game system network environment, as may be used to practice embodiments of the invention.

FIG. 4 is a screen shot of a wagering game educational system home web page showing various certification training programs and a logon section, consistent with an example embodiment of the invention.

FIG. 5 is a screen shot of a wagering game educational system web page showing level one game support technician courses comprising a part of the certification training program, consistent with an example embodiment of the invention.

FIG. 6 is a screen shot of a wagering game educational system web page showing certification training programs for a particular user, consistent with an example embodiment of the invention.

FIG. 7 is a screen shot of a wagering game educational system web page showing a math course as part of a M1 certification training program, consistent with an example embodiment of the invention.

FIG. 8 is a screen shot of a wagering game educational system web page showing a transcript for a particular user, consistent with an example embodiment of the invention.

FIG. 9 is a screen shot of a wagering game educational system web page showing account and transcript information for a particular user, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Some example embodiments of the invention comprise a computerized wagering game education system operable to present one or more interactive wagering game technical tasks to a student, to present a quiz to a student via the network interface such that the quiz results are used to provide suggestions for further study, and to present multiple levels of testing to a student as part of a certification process, comprising at least one quiz presented after the completion of at least one course and at least one certification test presented at the completion of multiple courses.

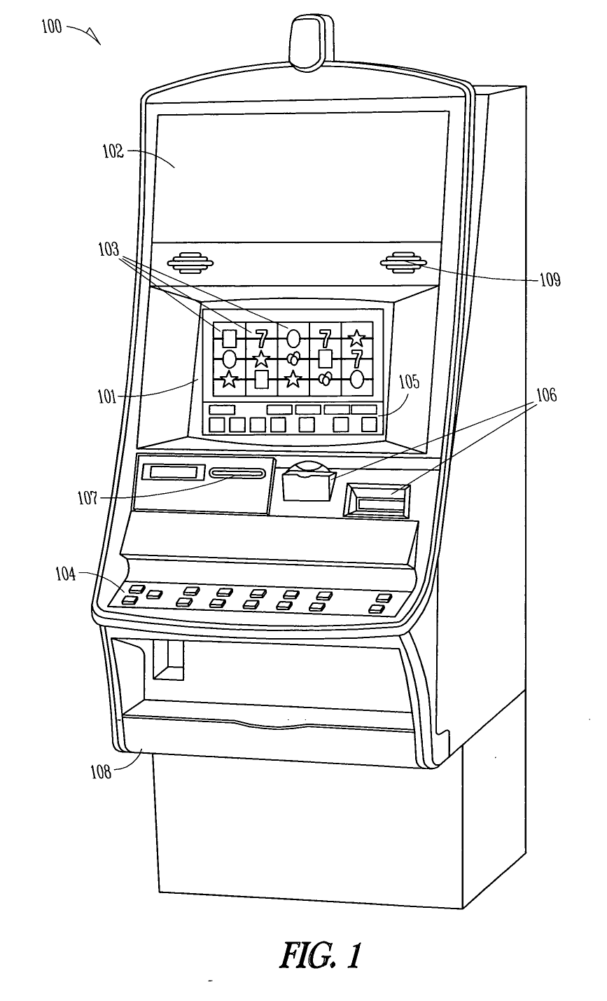

FIG. 1 illustrates a typical computerized wagering game machine, as may be used in some embodiments of the present invention. The computerized gaming system shown generally at 100 is a video wagering game system, which displays information for at least one wagering game upon which monetary value can be wagered on video display 101. In a further example, a second video display 102 is provided as a part of a top-box assembly, such as to display a bonus game or other information. Video displays 101 and 102 are in various embodiments a CRT display, a plasma display, an LCD display, a surface conducting electron emitter display, OLED display, or any other type of display suitable for displaying electronically provided display information. Alternate embodiments of the invention will have other game indicators, such as mechanical reels instead of the video graphics reels shown at 103 that comprise a part of a video slot machine wagering game.

A wagering game is presented using software within the wagering game machine, such as through instructions stored on a machine-readable medium such as a hard disk drive or nonvolatile memory, or that is provided via a network connection. In some further example embodiments, some or all of the software executed in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered.

The game of chance implemented via the loaded software takes various forms in different wagering game machines, including such well-known wagering games as reel slots, video poker, blackjack, craps, roulette, or hold 'em games. The wagering game is played and controlled with inputs such as various buttons 104 or via touchscreen overlay buttons 105 on video screen 101. In some alternate examples, other devices are employed to provide other input interfaces to the game player, such as a pull arm used to initiate reel spin.

Monetary value is typically wagered on the outcome of the games, such as with tokens, coins, bills, or cards that hold monetary value. The wagered value is conveyed to the machine through a changer 106 or a secure user identification module interface 107, and winnings are returned via the returned value card or through the coin tray 108. Sound is also provided through speakers 109, typically including audio indicators of game play, such as reel spins, credit bang-ups, and environmental or other sound effects or music to provide entertainment consistent with a theme of the computerized wagering game.

In some further embodiments, the wagering game machine is coupled to a network, and is operable to use its network connection to receive wagering game data, track players and monetary value associated with a player, and to perform other such functions. In other embodiments, the wagering game system is a portable wagering game system, or has another format different from that illustrated in FIG. 1.

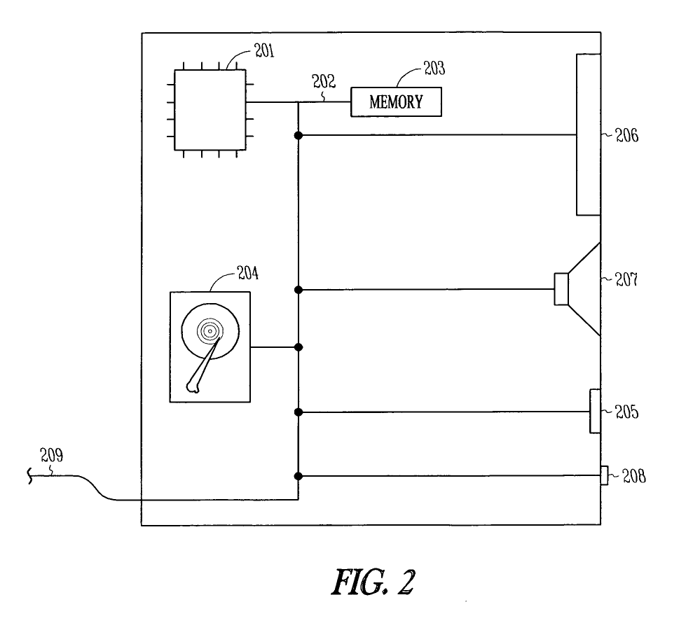

FIG. 2 shows a block diagram of an example embodiment of a wagering game system. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or Blu-Ray storage in the wagering game system.

The bus 202 also couples the processor and components to various other components, such as a value acceptor 205, which is in some embodiments a token acceptor, a card reader, or a biometric or wireless player identification reader. A touchscreen display 206 and speakers 207 serve to provide an interface between the wagering game system and a wagering game player, as do various other components such as buttons 208, pullarms, and joysticks. A network connection 209 couples the wagering game system to other wagering game machines and to a wagering gape server, such as to provide downloadable games or to provide accounting, player tracking, or other functions. These components are located in a wagering game machine cabinet such as that of FIG. 1 in some embodiments, but can be located in multiple enclosures comprising a wagering game system or outside a wagering game machine cabinet in other embodiments, or in alternate forms such as a wireless or mobile device.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual operations, and various combinations thereof. The wagering game machine is coupled to other wagering game machines, and to various other elements such as game servers, accounting servers, or community or progressive game servers via the network connection 209, and exchanges data with these machines via the network connection. In some environments, the wagering game systems above are used in complex environments, such as in progressive game groups that are either locally clustered or combined over a wide area. The wagering games are often linked by networks, including traditional wagering game machines such as that of FIG. 1 as well as portable or wireless wagering game systems and downloadable wagering game machines.

The wide variety of electronic technologies that are incorporated into wagering game machines and wagering game networks or systems requires a more sophisticated understanding of wagering game technologies to install, configure, and maintain a wagering game system. This knowledge is provided and verified in one example by use of an educational system. The educational system comprises in one embodiment a system that is operable to present one or more interactive wagering game technical tasks to a student, such as to instruct a wagering game technician in troubleshooting, module replacement, and configuration techniques by simulating the actions necessary to perform the tasks on a computerized system.

The instructional material is presented to the game technician by using a variety of media, such as interactive multimedia applications including sound, images, video, touchscreen simulation or actions, and other interfaces with a student.

In another example, a quiz is presented to the student such as over a network interface via a web browser such that the quiz results are used to provide suggestions for further study, such as by repeating certain portions of the course, by studying wagering game machine documents or training materials, or by performing certain tasks with wagering game machines as practice.

The wagering game educational system includes in some embodiments a variety of courses of specific topics or interests, some of which are grouped together to form various certification tracks. A game technician or student can elect to complete certain courses, or to work toward a certification that includes multiple courses as the part of certification track. The system of this example is operable to track successful completion of courses, as well as courses completed and remaining to be taken for various certification tracks for each student.

Another example embodiment comprises presenting multiple levels of testing to a student as part of a certification process, such as by presenting a quiz after the completion of each course in a certification program, and presenting a certification test upon completion of all the courses making up the certification program. The quizzes are used to provide feedback for further study and do not count toward the certification, while the certification test is used to determine certification.

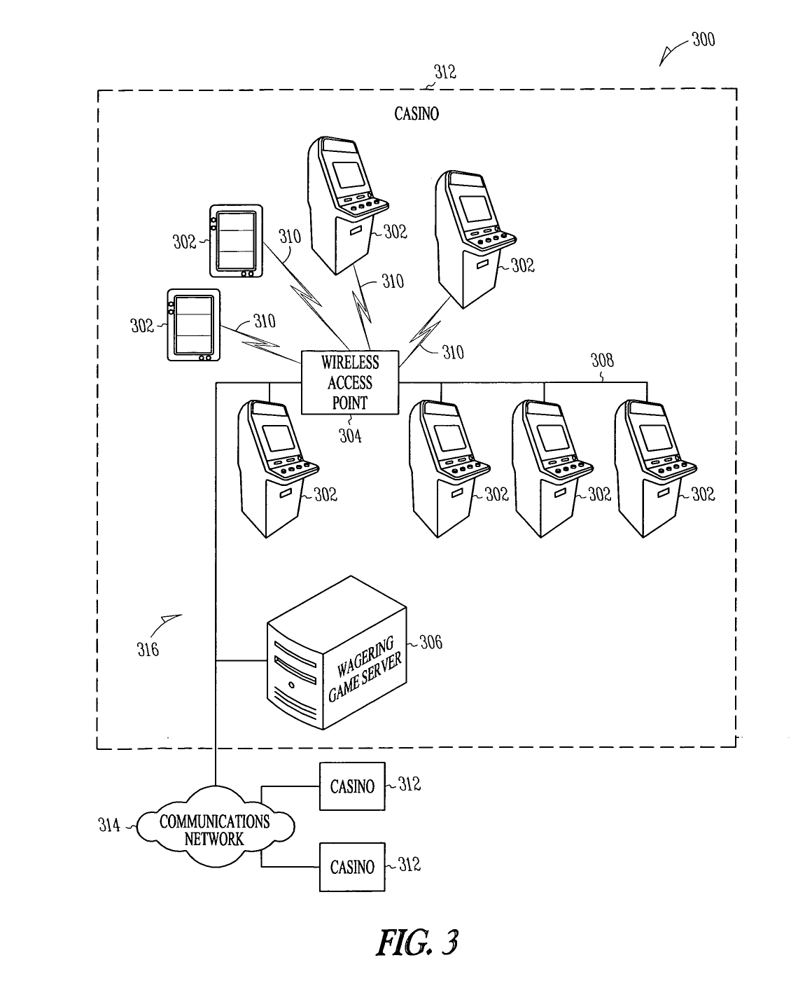

FIG. 3 illustrates a typical wagering game system network, as may be used to practice some embodiments of the invention. A communications network 314 such as the Internet links various casinos 312 and other networked systems, such as manufacturer websites used for training or software updates and other Internet systems. A wagering game server 306 within the casino provides accounting, downloadable games, progressive games, and other networked gaming functions to wired and wireless networked wagering game systems 302. In some embodiments, these game systems include web browser or other capabilities providing wagering game system educational system functionality to casino employees, while other computers are used in other embodiments.

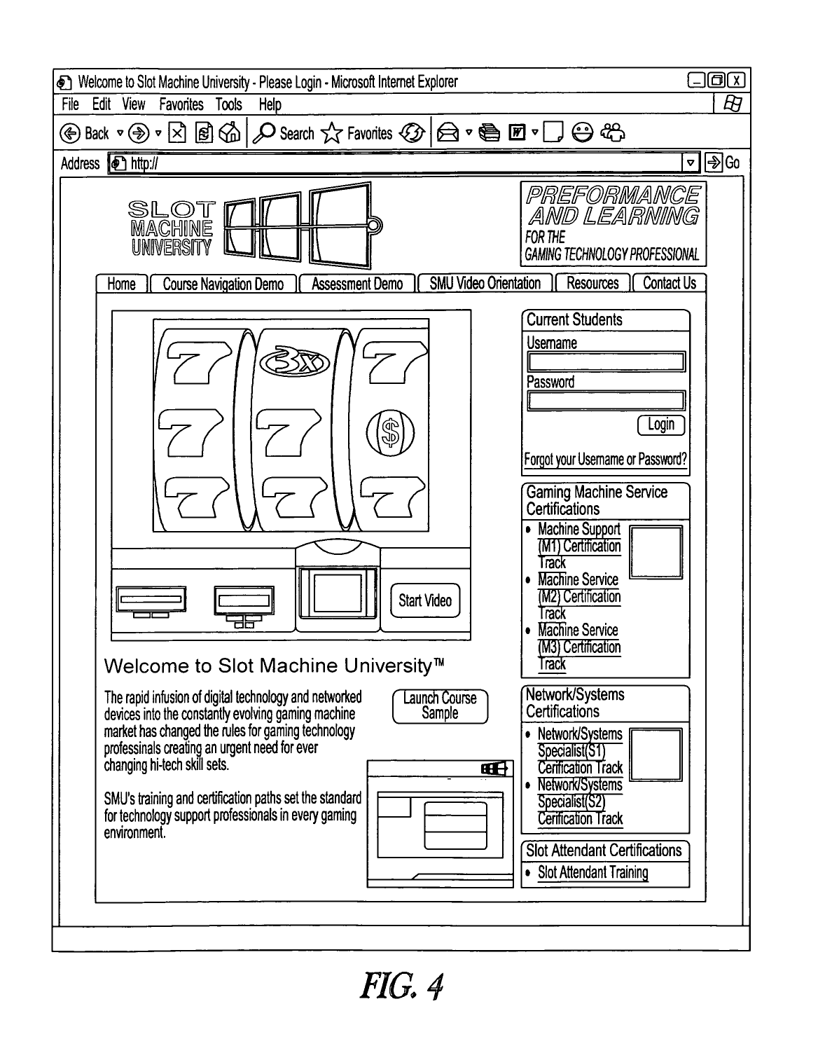

A networked computerized system connected to computer network 314 is in one example operable to display an Internet Web page, such as via a personal computer and a web browser application. One such example of this is illustrated in FIGS. 4-9. In FIG. 4, a home page or login page of a wagering game system educational system is shown. In this example, a user logon area is provided, along with links to demos, available courses, and certification programs. Here, the certification programs include machine support, network specialist levels one and two, and machine service levels two and three. Slot attendant training is also provided as a single course, and is in this example not a certification program comprising multiple courses.

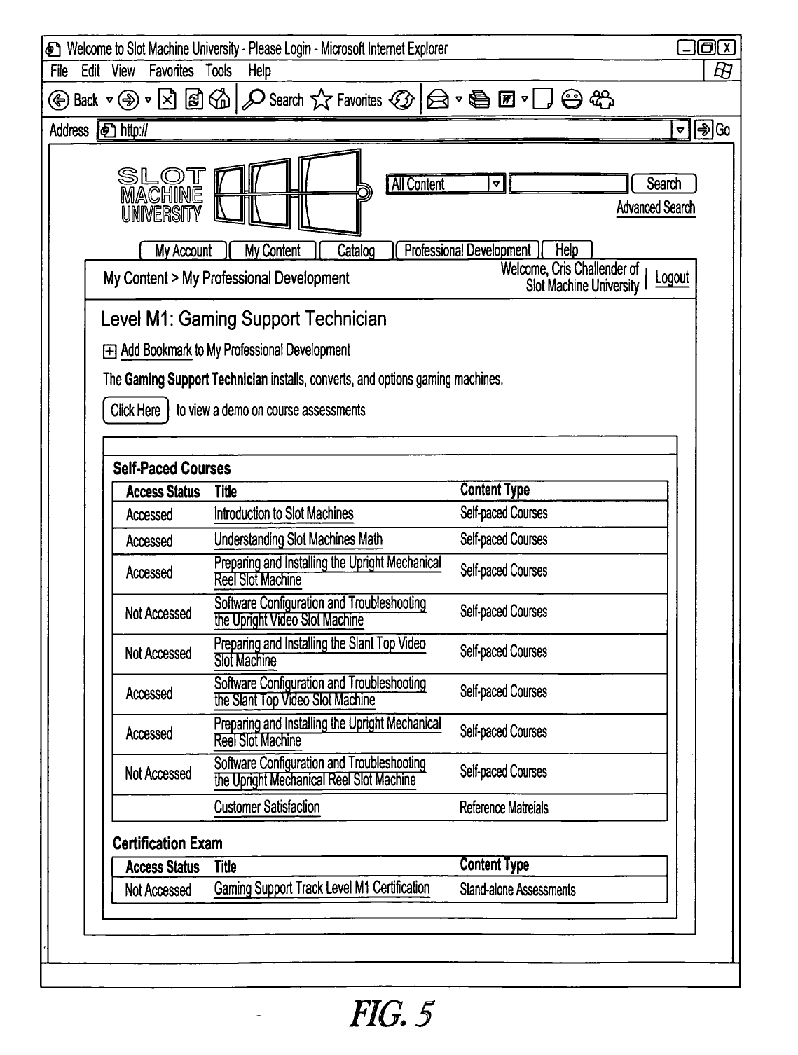

FIG. 5 is a screen shot of a wagering game educational system web page showing a list of level one game support technician courses that comprise a part of the certification training program, consistent with an example embodiment of the invention. Here, the courses are all listed as self-paced courses that the user proceeds through at his own pace, and includes the course title, an indication of whether each course has yet been accessed, and indicates the certification exam status. In some embodiments, the certification exam becomes available after completion of all courses comprising a part of the certification program, while in other embodiments the certification exam can be taken at any time.

The certification exam is a comprehensive exam covering subjects from multiple courses, which in some example embodiments include their own quizzes not used for certification purposes. In one such example, three different levels of quizzes or questions are presented to a user, including in-course questions to test understanding of topics before moving on to other topics in the course, a course-end quiz designed to test understanding of the course material, and a certification exam when the user has completed course studies for a particular certification program. In this example, the in-course questions and the course-end quiz do not count for certification, but are used to suggest areas of strength and weakness so that the user may focus further studies in areas of weakness or areas of interest.

In further embodiments, the quiz results are used to refer the user to various reference materials, such as training manuals, certain sections of the course, or outside exercises to conduct on a wagering game system.

The training material presented as a part of the course comprises in some embodiments interactive exercises that simulate various tasks. For example, a student may be asked to configure network parameters and confirm proper network operation of a simulated wagering game machine in a networking course by making selections, entering data, and performing other functions on a virtual or simulated wagering game machine presented during the course. In another example, the student will be asked to perform virtual tasks such as soldering components during a repair course, installing various wagering game components in a setup and configuration course, or make configuration selections and confirm proper operation in a slot management course.

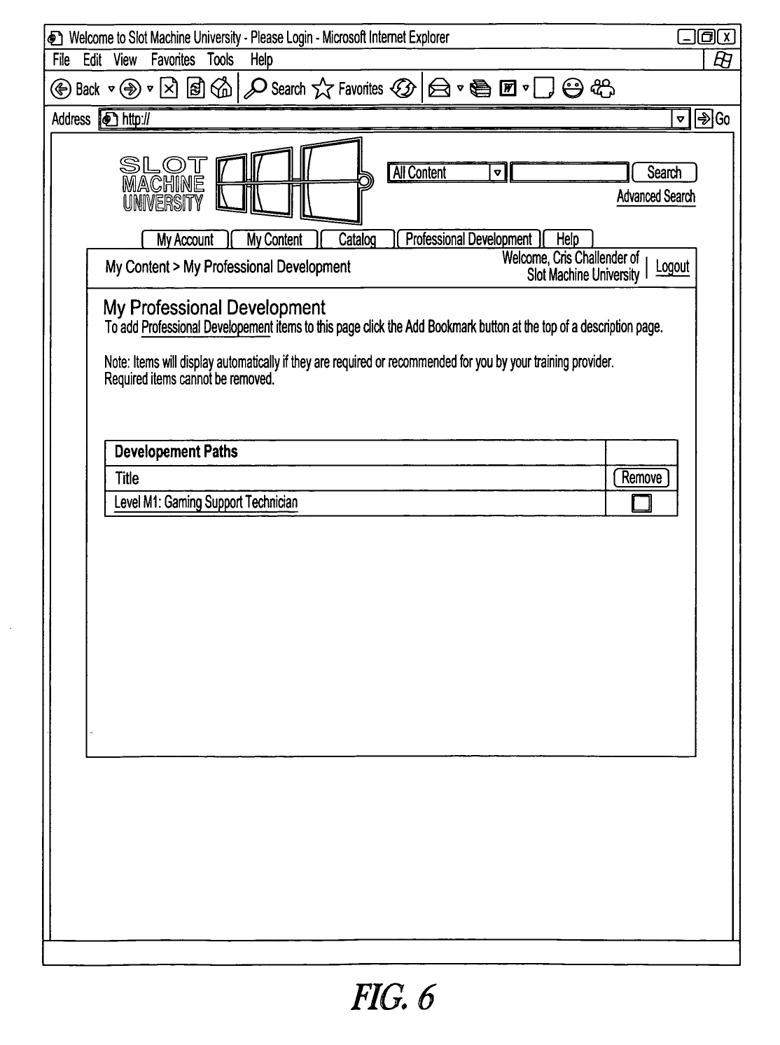

FIG. 6 shows a screen shot of a wagering game educational system web page showing certification training programs for a particular user, consistent with an example embodiment of the invention. Here, the user's development path as configured by the casino's training or education manager includes a single certification program, which is Level M1 Gaming Support Technician. After completion of this course, the casino's training manager may elect to promote the user or change the user's job responsibilities, and sign the user up for additional courses such as Level 2 or 3 certification as an advanced wagering game system technician.

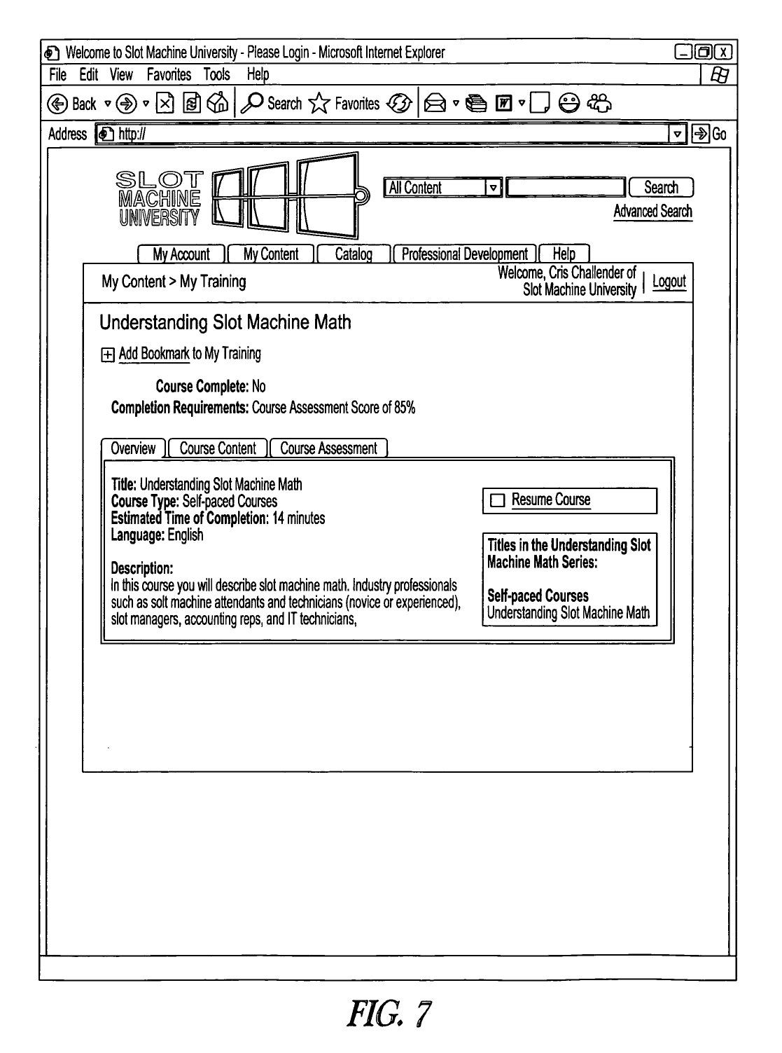

FIG. 7 similarly is a screen shot of a wagering game educational system web page showing a slot machine math certification course as part of the M1 Gaming Support Technician certification course, consistent with an example embodiment of the invention. In this example, the course is underway and can be resumed by clicking on the “Resume Course” link, and includes a link to a course test to be taken at the end of the course to obtain certification. Here, a score of 85% must be achieved on the course-end exam for the course to be considered complete as reflected on the course summary of FIG. 5.

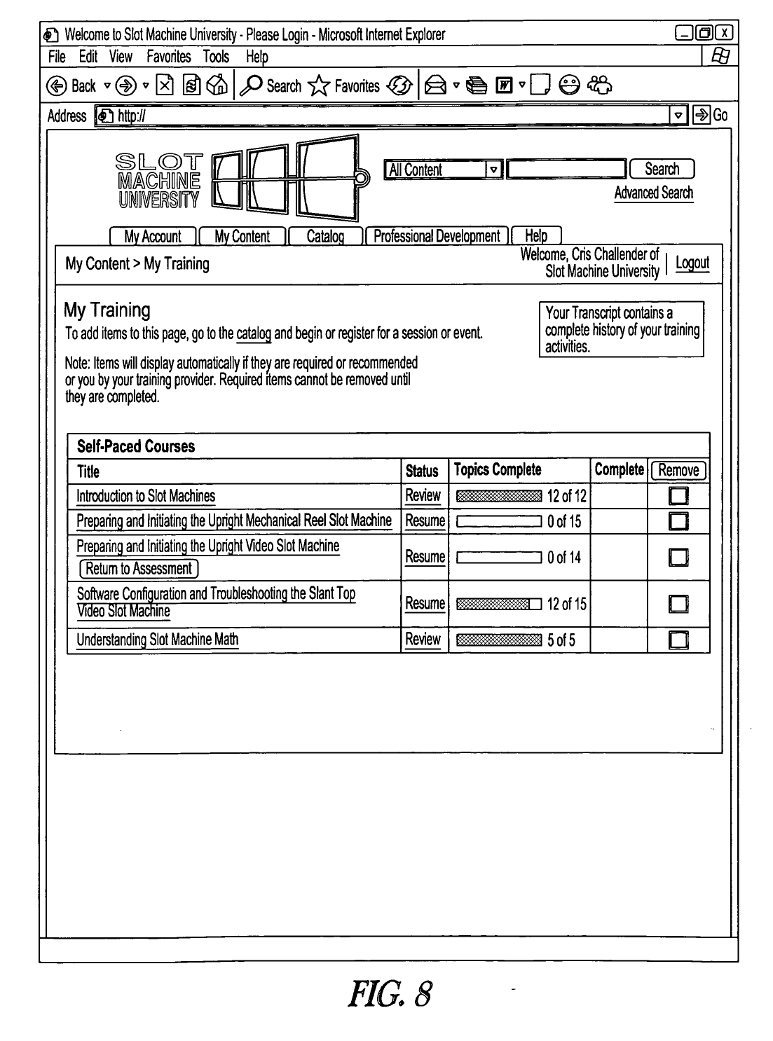

In FIG. 8, the screen shot shows a transcript of all course activity for a particular student, consistent with an example embodiment of the invention. This particular user is signed up for five courses, including Introduction to Slot Machines and Preparing and Installing the Upright Mechanical Reel Slot Machine. The user has completed twelve courses for the first program of study, but has completed none of the 15 courses for the second program of study, and has finished no certification exams as the Complete column has no completion marks.

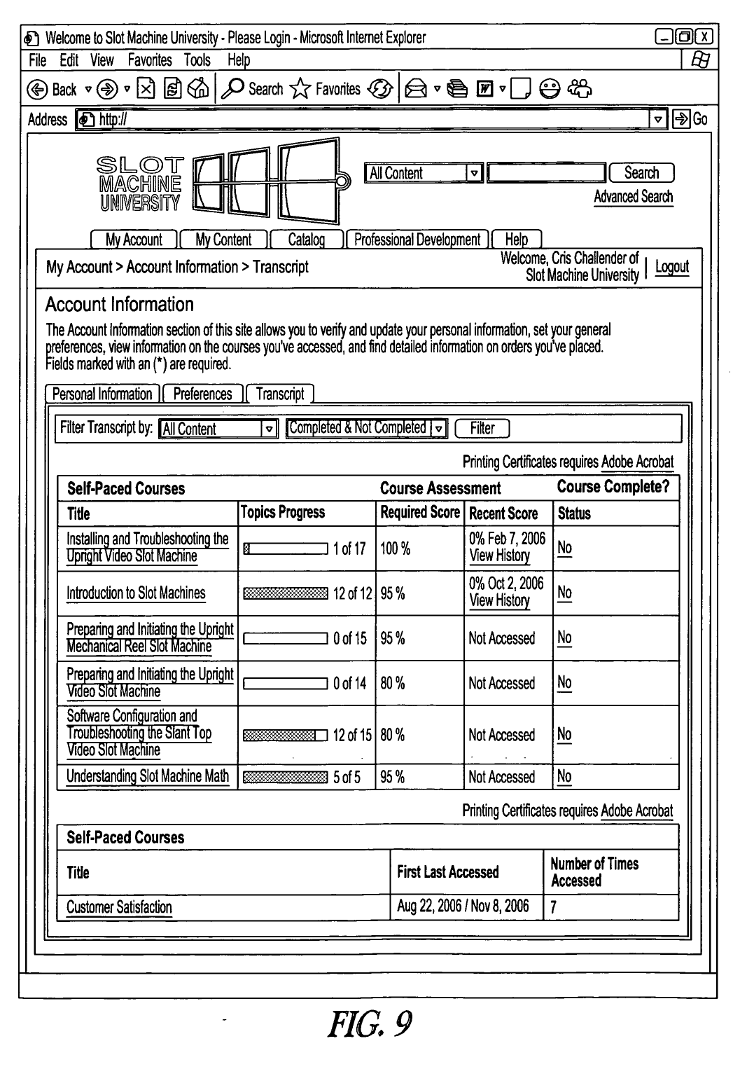

FIG. 9 is a screen shot showing account and transcript information for a user, consistent with an example embodiment of the invention. Here, the courses for a particular user are listed much as in FIG. 8, along with course assessment information such as the required certification exam score and certification exam results. In one example, the certification exam may be taken a limited number of times before it is no longer available to the user. In a further example, the user may take a certification exam a limited number of times, such as three times, for the price of the course, but will be charged an additional fee to take the exam a fourth, fifth, and possibly subsequent times.

The certification exam in some examples will vary from sitting to sitting, such as to prevent passing a test by memorization of the answers to a small number of questions rather than understanding the subject matter, by using different questions from a large pool of exam questions for different test instances. The questions may be ranked statistically, so that each exam is of similar difficulty either due to the difficulty of the questions presented or due to scaling of the completed exam score. Question statistics are also used to determine correlation between the way a user answers each question and the user's overall score, so that questions that are good indicators of a user's overall score can be retained while questions that are not good discriminators can be discarded or replaced.

The examples presented here have shown how some example embodiments of the invention present one or more interactive wagering game technical tasks to a student, present a quiz to a student via the network interface such that the quiz results are used to provide suggestions for further study, and present multiple levels of testing to a student as part of a certification process. These wagering game system educational system examples are only examples, and do not limit what is covered by the claims. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game machine educational system, comprising:
a server comprising a network interface operable to communicate via a network with one or more student computerized systems; and
a wagering game system education module on the server operable to present one or more interactive wagering game technical tasks to a student via the network interface.

2. The computerized wagering game machine educational system of claim 1, wherein the interactive wagering game technical tasks comprise at least one of configuring a wagering game machine, configuring a wagering game network, performing tests on a wagering game machine, or repairing a wagering game machine.

3. The computerized wagering game machine educational system of claim 1, further comprising a student computerized system comprising a web browser operable to communicate with the server.

4. The computerized wagering game machine educational system of claim 1, wherein the interactive wagering game technical tasks comprise instruction regarding the tasks and interactive simulations of the tasks.

5. A computerized wagering game machine educational system, comprising:
a server comprising a network interface operable to communicate via a network with one or more student computerized systems; and
a wagering game system education module on the server operable to present a quiz to a student via the network interface, and further operable to use the quiz results to provide suggestions for further study.

6. The computerized wagering game machine educational system of claim 5, wherein the quiz comprises student indication of interest in one or more quiz topics and this indication comprises a part of the quiz results.

7. The computerized wagering game machine educational system of claim 5, wherein the quiz results are further used to determine quality of quiz questions.

8. The computerized wagering game machine educational system of claim 5, wherein the suggestions for further study comprise at least one of further educational system course work, further outside reading, or hands-on activities.

9. A computerized wagering game machine educational system, comprising:
a server comprising a network interface operable to communicate via a network with one or more student computerized systems; and
a wagering game system education module on the server operable to present multiple levels of testing to a student as part of a certification process.

10. The computerized wagering game machine educational system of claim 9, wherein the multiple levels of testing comprises at least one quiz presented after the completion of at least one course; and at least one certification test presented at the completion of multiple courses.

11. The computerized wagering game machine educational system of claim 10, wherein the at least one certification test is used to determine certification, and the at least one quiz is not used to determine certification.

12. The computerized wagering game machine educational system of claim 10, wherein the at least one quiz presented after the completion of at least one course is used to suggest areas for further study.

13. The computerized wagering game machine educational system of claim 10, wherein the at least one certification test can be retaken a limited number of times to obtain certification.

14. The computerized wagering game machine educational system of claim 13, wherein certification test attempts past the limited number of times can be purchased for an additional fee.

15. The computerized wagering game machine educational system of claim 9, further comprising at least one quiz presented during presentation of a course.

16. The computerized wagering game system educational system of claim 15, wherein the at least one quiz presented during presentation of a course is used to determine subsequent presentation of material during the course.

17. A method of presenting computerized wagering game machine educational material, comprising:
presenting one or more interactive wagering game technical tasks to a student via a computerized system.

18. A method of presenting computerized wagering game machine educational material, comprising:
presenting a quiz to a student via a computerized system; and
using the quiz results to provide suggestions via the computerized system for further study.

19. A method of presenting computerized wagering game machine educational material, comprising:
presenting multiple levels of testing to a student as part of a certification process, comprising at least one quiz presented after the completion of at least one course and at least one certification test presented at the completion of multiple courses.
